(19) United States
(12) Patent Application Publication
(10) Pub. No.: US 2006/0209374 A1
(43) Pub. Date: Sep. 21, 2006

(54) Projection device

(75) Inventor: Oscar Hendrikus Willemsen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/564,420

(22) PCT Filed: Jul. 7, 2004
(86) PCT No.: PCT/IB04/51148

§ 371 Date: Jan. 11, 2006

(30) Foreign Application Priority Data
Jul. 14, 2003 (EP) 03102140.5

(51) Int. Cl. G02B 26/08

(52) U.S. Cl. 359/205

(57) ABSTRACT

A projection device, comprising means (4a, 4b, 5, 6) for directing a plurality of light beams (3a, 3b, 3c) onto a scanning device (13), adapted to scan said beams in order to project an image on a surface. The device has an adjustable lens arranged in the optical path of said beams after said scanner so that the scanner is located between the lens and its focal length. Through this arrangement, the adjustable lens will enable a reduction of the angular spread of the projection, without reducing the resolution of the displayed image. This, in turn, enables a projection of an image at a desired distance, while such a size is maintained that the available light intensity is sufficient.

The present invention relates to a projection device, comprising means for directing a plurality of light beams onto a scanning device adapted to scan said beams in order to project an image on a surface.

Today, micromachined scanners are being developed that have the potential to scan a laser beam at a high frequency and with a large optical scan angle. Such scanners, combining weak cantilever or torsion suspension springs and a very small mirror mass, can have a resonant frequency that is sufficiently high for raster scanning a laser beam at video rate, i.e. in the order of 10 kHz.

The small mass of the scanner implies that the reflecting surface of the beam scanner must be very small, typically 150*150 μm². With such a small area, diffraction effects cause a considerable angular spread in the deflected beam, and in order to obtain a satisfactory resolution the optical scan angle needs to be quite large. It can be shown that a green laser beam with ideal properties would allow approximately 300 resolvable points at a scan angle of 60 degrees.

Recently, it has also been suggested to provide a mobile device, such as a mobile phone or a personal digital assistant, with a micro projector, see e.g. WO02/43041 and JP 2001/094905. Such a device may allow the user to choose between viewing on a screen of the device, or projecting the image at a distance from the device.

Such a micro projector may comprise a scanner of the above mentioned type. With a scan angle of 60 degrees it would be possible to project an image with the size of an A5 paper at a distance of 17 cm. This short viewing distance can be very useful for personal viewing, such as reading your e-mail or watching video, but the user may also like to display an image at larger distances. For instance, for sharing images with your friends, you would like to display the image at a distance of 50 cm or more.

Since the laser beam that is reflected from the scanner is collimated, displaying an image with the same optical scan angle at that distance would still result in a sharp image. However, the area is enlarged to such an extent that the brightness of the image will be insufficient.

In order to maintain the same image area, the scan angle can be reduced by reducing the driving amplitude. However, as mentioned above, the scan angle must not be reduced, as this leads to deteriorated image resolution.

Alternatively, a positive lens can be positioned such that the scanned beam passes it. However, this would exclude projecting the image at a closer distance.

An optical unit that can enlarge the scan angle of a laser beam with a variable factor is already known for professional display applications. For instance, Schneider technologies (http://www.schneider-ag.de) already uses a transformation optical system with a zoom option to vary the image size. However, this system is optimized for a professional projector that can project an image of several square meters. Since the intensity of the laser beam is very high, high quality lenses have to be used in combination with a mechanical focus system. This is unacceptable in a mobile device for reasons of price and size.

An object of the present invention is to provide a device for micro projection capable of projecting an image at different distances with unaltered resolution and size. A further object is to provide such a device that is compact, cost-effective and does not include moving parts.

These and further objects are achieved with a projection device of the kind mentioned in the introductory paragraph, wherein an adjustable lens is arranged in the optical path of said beams after said scanner so that the scanner is located between the lens and the focal length of the lens.

By this arrangement, the adjustable lens will enable a reduction of the angular spread of the projection, without reducing the resolution of the displayed image. This, in turn, enables a projection of an image at a desired distance, while maintaining such a size that the available light intensity is sufficient.

According to a preferred embodiment, the adjustable lens is an electro-wetting lens. Such a lens has suitable optical properties for the application, and can be voltage controlled in a simple manner.

Preferably, the adjustable lens has at least two refractive surfaces, enabling an improved.

According to one embodiment, the beams are of different color and the projector comprises means to modulate said beams and to form one combined beam. Further, the scanner is a two-dimensional scanner arranged to scan the combined beam in a raster pattern. Alternatively, an array of beams extending in one direction are formed by an array of light modulators or light valves, and the scanner is arranged to scan the array of beams in a direction perpendicular to the array.

These and other aspects of the present invention will now be described in more detail, with reference to the appended drawings showing currently preferred embodiments of the invention.

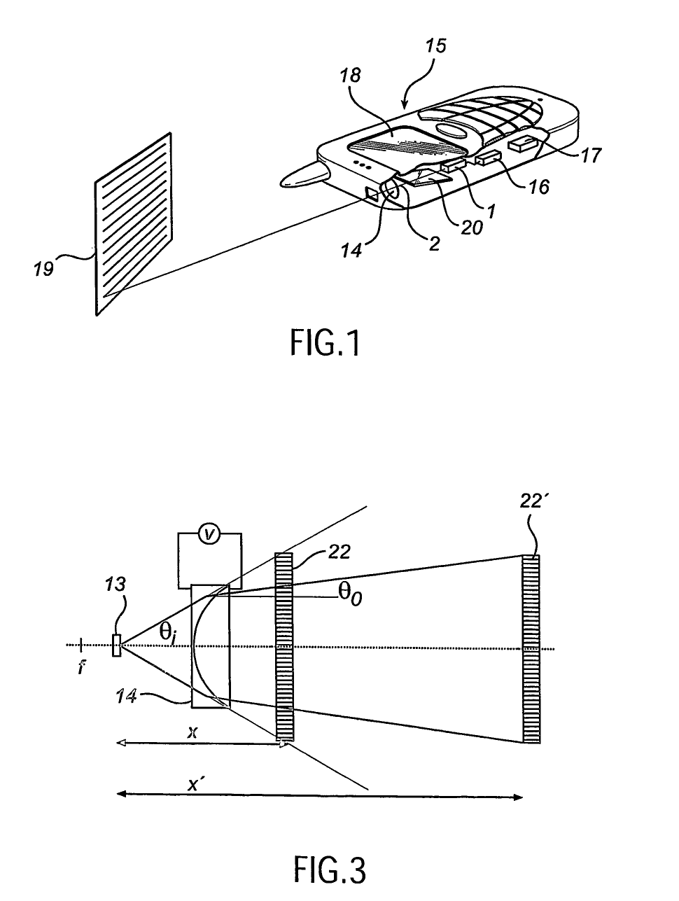

FIG. 1 is a perspective view of a mobile phone provided with a projecting device according to an embodiment of the invention.

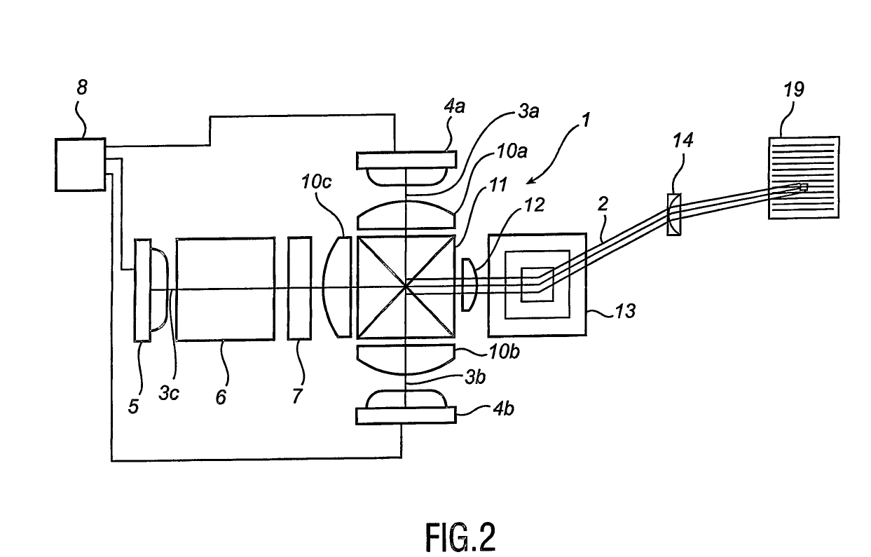

FIG. 2 is a schematic view of the projecting device in the mobile phone in FIG. 1.

FIG. 3 is a diagram showing the optical path of the projecting beam of the projector in FIG. 2.

A projecting device 1 according to the invention can be advantageously implemented in a mobile device 15, such as a mobile phone as shown in FIG. 1. The mobile device 15 is typically equipped with a memory 16 to store images, and/or with a wireless communication unit 17 to download video or data streams. The images or video sequences can then be viewed on the display 18 of the device 15, or projected on a remote surface 19 using the projecting device 1. In the illustrated case, the same projecting device 1 is used for both types of viewing, and the selection between rear or front projection is achieved by a mirroring surface 20 arranged in the optical path of the light beam 2 from the projecting device 1.

The projecting device 1, which is shown in more detail in FIG. 2, has dimensions that are such that it can be fitted in the mobile device 15. Typically this means in the order of 10 mm by 10 mm.

In the illustrated projecting device 1, a desired color is obtained by combining red, blue and green laser beams 3a, 3b, 3c at a ratio defined by a video signal. The combined laser beam 2 is then directed towards a scanning device 13, and scanned on a screen 19 to obtain a color image.

The red and blue colored laser beams are preferably created by laser diodes 4a, 4b, emitting light in the red and blue wavelength area, respectively. While red and blue laser diodes are presently commercially available, green laser diodes are presently not (although they are expected to be in the future). In the illustrated projector, green light is therefore created by a diode pump 5 feeding infrared light to a crystal 6 that converts two photons of infrared to one photon of green light. Another option (not shown) is to use an up-conversion fiber that acts as a laser when it is pumped with a UV laser diode. Yet another option is to use an optically pumped semiconductor laser (OPSL) for generation of the green (and blue) light. If the green light cannot be modulated at the video frequency by modulating the diode pump 5, a light modulator 7 can be included in the optical path of the green beam.

A driver 8 is arranged to receive video signals containing video information, and to modulate the laser beams 3a, 3b, 3c in accordance with this information. The device further comprises a set of lenses 10a, 10b, 10c arranged around a dichroic mirror 11, and a further lens 12 arranged between the dichroic mirror and a scanning device 13 according to the invention. The dichroic mirror 11 can be a dichroic cube of a kind well-known from LCD projectors, and is advantageously quite small and thus cheap.

By passing the lenses 10a, 10b, 10c, 12 and the dichroic mirror 11, the laser beams 3a, 3b, 3c are combined and collimated to a parallel beam 2 that fits onto the scanning device 13. For instance, light from the red laser diode 4a is focused by a first lens 10a, after which it is combined in the dichroic mirror 11 and collimated with a small lens 12. The detail of the lenses, their mutual distances and their strengths can be determined by the person skilled in the art.

According to the invention, at least one adjustable lens 14 is arranged in the optical path of the beam(s) between the scanner and the aperture of the device. Advantageously, the lens 14 is located such that it does not interfere with the optical path between the scanner 13 and the rear projecting display 18. The lens 14 is arranged such that the scanning device 13 is closer to the lens 14 than the focal length f of the lens. According to one embodiment, the lens is an electro-wetting lens that can be actuated with a voltage to change its strength. Examples of adjustable lenses suitable for embodying the invention are described in e.g. WO 99/18546 and WO 00/58763, herewith incorporated by reference.

The strength of the lens 14 can be varied by the user, to allow for an image of suitable size to be projected at a desired distance. For this purpose, the mobile device 15 can be provided with a mechanic control or a software generated menu item, for generating a control signal to regulate the voltage applied to the lens.

An illustration of the light path in the device 15 is shown in FIG. 3. In the figure it is assumed that the optical scan angle of the beam is 60 degrees. Without any adjustable lens, or if the strength of the adjustable lens is zero, an image 22 of a given size is projected at a distance x. By applying a voltage V to the electro-wetting lens 14, the strength will be increased and an image 22′ with the same size as the image 22, is obtained at a distance x′.

If the electro-wetting lens is treated as a thin lens, the following relationship for the angle of the beam with the optical axis holds:

$$\frac{tan {θ}_{i}}{tan {θ}_{o}} = - \frac{b}{v} = \frac{f}{f - v} , \qquad ( Eq . 1 )$$

where θᵢ is the angle of the beam before passing the lens, θₒ is the angle of the beam after passing the lens, b is the image distance, v is the object distance and f is the focal distance.

The lens in FIG. 3 is completely filled, which is the most preferred situation, since the intensity of the light in the lens is lowest and the distance between lens and scanner is minimal. Assuming a completely filled lens, the following relation holds:

$$tan {θ}_{i} = \frac{R}{v} , \qquad ( Eq . 2 )$$

where R is the radius of the electro-wetting lens.

In the case of an electro-wetting lens we know that the focal distance of the lens is determined by the radius of the sphere that is created by the interface of the two liquids of the lens and by the difference of the refractive indices of the lens. The relationship is:

$$f = \frac{R}{( {n}_{2} - {n}_{1} )} \qquad ( Eq . 3 )$$

By substituting equation 2 and 3 in equation 1, the following equation is obtained:
tan θᵥ=tan θᵢ−(n₁−n₂) (Eq. 4)

For the electro-wetting lens, the difference between the indices of refraction n₁−n₂ can be 0.3 maximum. For an incident angle of 30 degrees (60 degrees optical scan angle) the lens reduces the angle of the refracted beam to 15 degrees. The resulting projection angle of 22 degrees enables to project an A5 image at a distance of 38 cm, which can be compared to 17 cm which was the situation without the adjustable lens. A distance of 38 cm is close to suitable for applications related to information sharing.

If the electro-wetting lens is further adapted such that it has two planes of refraction, the projection angle can be decreased even further. For such a second lens action, similar formulae as mentioned above can be derived. At a reduction of the refracted angle to 11 degrees (optical scan angle of 22 degrees), which is easy to achieve with a second refraction plane, it is possible to project the A5 image at a distance of one meter.

Further embodiments of the present invention can be obtained by variations of the above example. For example, the laser beam projector can be of a different type than a raster scanning device. Instead, the beams from a one-dimensional array of light sources or light valves can be scanned with a one dimensional beam scanner. The projecting device may alternatively use a micro-display, such as a HPTS, LCOS or DMD panel. In some of these cases, a projection lens may be required, and this lens can then be made variable with the electro-wetting principle.

Further, the adjustable lens can also be of a different type. For instance, liquid crystal lenses can also be made variable. See for more information O. A. Zayakin, M. Yu. Loktev, G. D. Love, & A. F. Naumov. Proc. Soc. Photo-Opt. Instum. Eng IV International Syposium Optics of the Atmosphere and Ocean, Tomsk, Russia, Jun. 23-26, (1999) or G. D. Love and A. F. Naumov. Liquid Crystals Today. (The Newsletter of the International Liquid Crystal Society) 10(1):1-4 (2001).

The display 18 of the mobile device 15 is of course not necessarily driven by the projecting device, but can equally well be a separately driven display device, such as an LCD, a dynamic foil display or a plasma display.

1. A projection device, comprising:
means (4a, 4b, 5, 6) for directing a plurality of light beams (3a, 3b, 3c) onto a scanning device (13), adapted to scan said beams in order to project an image on a surface, characterized by an adjustable lens arranged in the optical path of said beams after said scanner so that the scanner is located between the lens and its focal length.

2. A projection device according to claim 1, wherein said lens is an electro-wetting lens.

3. A projection device according to claim 1, wherein said lens has at least two refractive planes.

4. A projection device according to claim 1, wherein the beams (3a, 3b, 3c) are of different color, wherein the projection device comprises means (10a, 10b, 10c, 11, 12) to modulate said beams and to form one combined beam (2), and wherein said scanner (13) is a two-dimensional scanner arranged to scan the combined beam in a raster pattern.

5. A projection device according to claim 1, wherein the beams form an array extending in one direction, and wherein said scanner is arranged to scan said array of beams in a second direction.
